(19) United States
(12) Patent Application Publication
(10) Pub. No.: US 2014/0008090 A1
(43) Pub. Date: Jan. 9, 2014

(54) Handheld Power Tools with Triggers and Methods for Assembling Same

(71) Applicant: Ingersoll-Rand Company, Davidson, NC (US)

(72) Inventors: Christopher Anthony Kokinelis, Flemington, NJ (US); Randolph Robert Ruetsch, Branchburg, NJ (US); Vikram Madineni, Somerset, NJ (US)

(73) Assignee: Ingersoll-Rand Company, Davidson, NC (US)

(21) Appl. No.: 14/023,057

(22) Filed: Sep. 10, 2013

Related U.S. Application Data
(63) Continuation-in-part of application No. PCT/US2011/030650, filed on Mar. 31, 2011.
(60) Provisional application No. 61/777,093, filed on Mar. 12, 2013.

(51) Int. Cl. B25F 5/02

(52) U.S. Cl. CPC B25F 5/02
USPC 173/170; 29/428

(57) ABSTRACT

The housing assembly has a grip portion having a heightwise axis. The housing assembly includes a housing member having parallel upper and lower housing guide features spaced apart along the heightwise axis. The trigger member is mounted in the housing assembly to slide along a slide axis transverse to the heightwise axis. The trigger member includes parallel upper and lower trigger guide features spaced apart along the heightwise axis and mated with the upper and lower housing guide features. The upper and lower housing guide features and the upper and lower trigger guide features cooperate to limit the trigger member to a linear slide path relative to the housing assembly and inhibit cocking of the trigger member about a lateral axis transverse to each of the heightwise axis and the slide axis.

### RELATED APPLICATION(S)

This application is a continuation-in-part application of International Application Serial No. PCT/US2011/030650, filed Mar. 31, 2011, and claims the benefit of U.S. Provisional Application No. 61/777,093, filed Mar. 12, 2013, the disclosures of which are incorporated by reference herein in their entireties.

### FIELD OF THE INVENTION

The present invention relates to handheld power tools and, more particularly, to handheld power tools having a trigger for actuation of the handheld power tool.

### BACKGROUND OF THE INVENTION

Handheld power tools commonly include a trigger that an operator can selectively depress to actuate the power tool.

### SUMMARY OF THE INVENTION

According to embodiments of the present invention, a handheld power tool includes a housing assembly and a trigger member. The housing assembly has a grip portion having a heightwise axis. The housing assembly includes a housing member having parallel upper and lower housing guide features spaced apart along the heightwise axis. The trigger member is mounted in the housing assembly to slide along a slide axis transverse to the heightwise axis. The trigger member includes parallel upper and lower trigger guide features spaced apart along the heightwise axis and mated with the upper and lower housing guide features. The upper and lower housing guide features and the upper and lower trigger guide features cooperate to limit the trigger member to a linear slide path relative to the housing assembly and inhibit cocking of the trigger member about a lateral axis transverse to each of the heightwise axis and the slide axis.

In some embodiments, the housing member is a first housing member, the housing assembly further includes a second housing member and the first and second housing members collectively define the grip portion. The trigger member is captured between and directly mounted on each of the first and second housing members.

According to some embodiments, the upper and lower housing guide features include upper and lower linear guide ribs, respectively, and the upper and lower trigger guide features include upper and lower linear guide slots, respectively. The upper and lower linear guide ribs are slidably nested in the upper and lower linear guide slots, respectively.

In some embodiments, the trigger member has first and second opposed lateral sides spaced apart along the lateral axis. The upper and lower trigger guide features are located on the first lateral side of the trigger member and there are no guide features on the second lateral side of the trigger member.

According to some embodiments, the trigger member is a monolithic body.

The handheld power tool may include a noncontact switch system including a Hall Effect sensor mounted on or in the housing assembly, and a magnet mounted on the trigger member for movement therewith relative to the Hall Effect sensor. In some embodiments, the Hall Effect sensor is a latching Hall Effect sensor. According to some embodiments, the Hall Effect sensor is configured to provide a variable output signal that is a function of a magnetic field applied to the Hall Effect sensor by the magnet, wherein the applied magnetic field strength is a function of the position of the trigger member with respect to the Hall Effect sensor. In some embodiments, the Hall Effect sensor is a linear Hall Effect sensor and the variable output signal is substantially proportional to the strength of the magnetic field applied to the linear Hall Effect sensor by the magnet, wherein the applied magnetic field strength is substantially proportional to the position of the trigger member with respect to the linear Hall Effect sensor.

In some embodiments, the handheld power tool includes a biasing member biasing the trigger member into an extended position.

The handheld power tool may be a cordless handheld power tool powered by a battery pack.

According to method embodiments of the present invention, a method for assembling a handheld power tool includes: providing a housing assembly having a grip portion having a heightwise axis, the housing assembly including a housing member having parallel upper and lower housing guide features spaced apart along the heightwise axis; and mounting a trigger member in the housing assembly to slide along a slide axis transverse to the heightwise axis, and such that parallel upper and lower trigger guide features of the trigger member are spaced apart along the heightwise axis and mated with the upper and lower housing guide features. In the assembled handheld power tool, the upper and lower housing guide features and the upper and lower trigger guide features cooperate to limit the trigger member to a linear slide path relative to the housing assembly and inhibit cocking of the trigger member about a lateral axis transverse to each of the heightwise axis and the slide axis.

According to some embodiments, the housing member is a first housing member, the housing assembly further includes a second housing member, and mounting the trigger member in the housing assembly includes capturing the trigger member between the first and second housing members such that the trigger member is directly mounted on each of the first and second housing members and the first and second housing members collectively define the grip portion.

In some embodiments, the upper and lower housing guide features include upper and lower linear guide ribs, respectively, and the upper and lower trigger guide features include upper and lower linear guide slots, respectively. Mounting the trigger member in the housing assembly includes slidably nesting the upper and lower linear guide ribs in the upper and lower linear guide slots, respectively.

According to some embodiments, the trigger member has first and second opposed lateral sides spaced apart along the lateral axis. The upper and lower trigger guide features are located on the first lateral side of the trigger member and there are no guide features on the second lateral side of the trigger member.

In some embodiments, the method includes unitarily injection molding the trigger member.

The method may include assembling a noncontact switch system in the housing assembly, including: mounting a Hall Effect sensor on or in the housing assembly; and mounting a magnet on the trigger member for movement therewith relative to the Hall Effect sensor.

The method may include mounting a biasing member in the housing assembly to bias the trigger member into an extended position.

In some embodiments, the handheld power tool is a cordless handheld power tool and the method includes mounting a battery pack on the housing assembly.

According to embodiments of the present invention, a trigger member for a handheld power tool includes a body having an engagement face and first and second opposed lateral side faces. The trigger member further includes upper and lower extensions extending axially from the body adjacent the first lateral side face, and upper and lower linear guide slots defined in the upper and lower extensions, respectively.

In some embodiments, the second lateral side face is devoid of guide features.

In some embodiments, the trigger member is a monolithic body. The trigger member may be unitarily injection molded.

According to embodiments of the invention, a handheld power tool includes a housing, an electric motor mounted in the housing, and a trigger system. The trigger system includes a trigger member movably mounted in the housing, and a noncontact switch system to selectively control actuation of the electric motor. The noncontact switch system includes a Hall Effect sensor mounted on or in the housing, and a magnet mounted on the trigger member for movement therewith relative to the Hall Effect sensor.

In some embodiments, the Hall Effect sensor is a latching Hall Effect sensor.

According to some embodiments, the Hall Effect sensor is configured to provide a variable output signal that is a function of a magnetic field applied to the Hall Effect sensor by the magnet, wherein the applied magnetic field strength is a function of the position of the trigger member with respect to the Hall Effect sensor. In some embodiments, the Hall Effect sensor is a linear Hall Effect sensor and the variable output signal is substantially proportional to the strength of the magnetic field applied to the linear Hall Effect sensor by the magnet, wherein the applied magnetic field strength is substantially proportional to the position of the trigger member with respect to the linear Hall Effect sensor.

The foregoing and other objects and aspects of the present invention are explained in detail in the specification set forth below.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

### BRIEF DESCRIPTION OF THE DRAWINGS

FIG. 1 is a front perspective view of a handheld power tool according to embodiments of the present invention including a trigger system according to embodiments of the present invention.

FIG. 2 is an exploded, front perspective view of the handheld power tool of FIG. 1.

FIG. 3 is a front perspective view of a right housing member forming a part of the handheld power tool of FIG. 1.

FIG. 4 is a front perspective view of a left housing member forming a part of the handheld power tool of FIG. 1.

FIG. 5 is a rear perspective view of a trigger member forming a part of the trigger system of FIG. 1.

FIG. 6 is a right side elevational view of the trigger member of FIG. 5.

FIG. 7 is a left side elevational view of the trigger member of FIG. 5.

FIG. 8 is a rear end view of the trigger member of FIG. 5.

FIG. 9 is an enlarged, fragmentary, left side view of the handheld power tool of FIG. 1 with the trigger member in an extended position.

FIG. 10 is a cross-sectional view of the handheld power tool of FIG. 1 taken along the line 10-10 of FIG. 9 with the trigger member in the extended position.

FIG. 11 is an enlarged, fragmentary, left side view of the handheld power tool of FIG. 1 with the trigger member in a retracted position.

FIG. 12 is a schematic electrical diagram of the handheld power tool of FIG. 1.

FIG. 13 is an enlarged, fragmentary, left side view of a handheld power tool according to further embodiments of the present invention with a trigger member thereof in an extended position.

FIG. 14 is an enlarged, fragmentary, left side view of the handheld power tool of FIG. 13 with the trigger member in a retracted position.

FIG. 15 is a schematic electrical diagram of the handheld power tool of FIG. 13.

### DETAILED DESCRIPTION OF THE EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The term “cordless” power tool refers to power tools that do not require plug-in, hard wired electrical connections to an external power source to operate. Rather, the cordless power tools have electric motors that are powered by on-board batteries, such as rechargeable batteries. A range of batteries may fit a range of cordless tools. Different cordless power tools may have a variety of electrical current demand profiles that operate more efficiently with batteries providing a suitable range of voltages and current capacities. The different cordless (e.g., battery powered) power tools can include, for example, screwdrivers, ratchets, nutrunners, impacts and the like.

Embodiments of the invention may be particularly suitable for precision power tool that can be used for applications where more exact control of the applied output is desired.

As used herein, “monolithic” means an object that is a single, unitary piece formed or composed of a material without joints or seams.

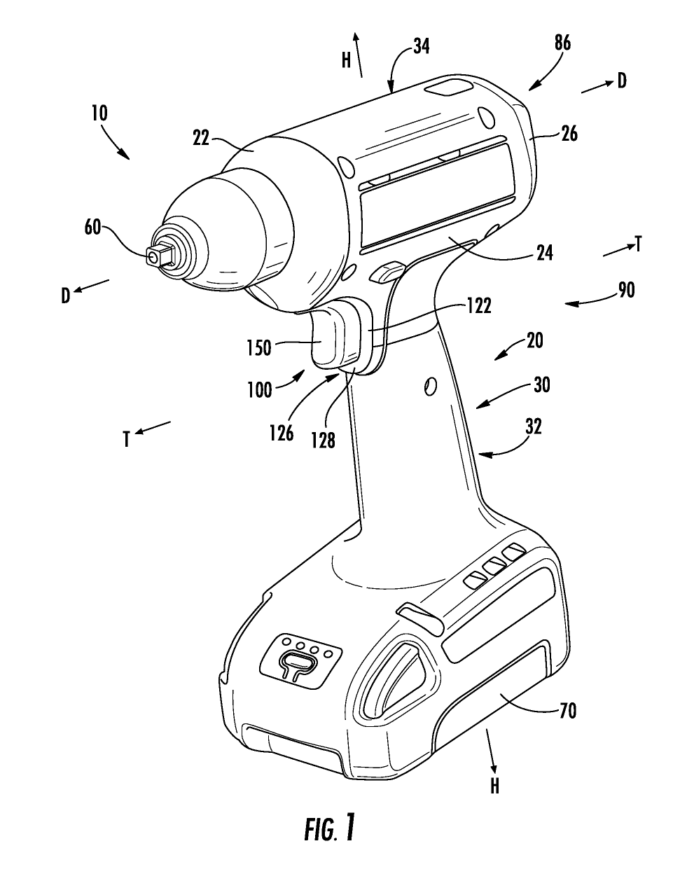

With reference to FIGS. 1-11, a handheld power tool 10 according to embodiments of the present invention is shown therein. The handheld power tool 10 includes a trigger system 100 according to embodiments of the present invention. The power tool 10 may be any suitable type of handheld power tool and, according to some embodiments, is an electrically powered handheld power tool.

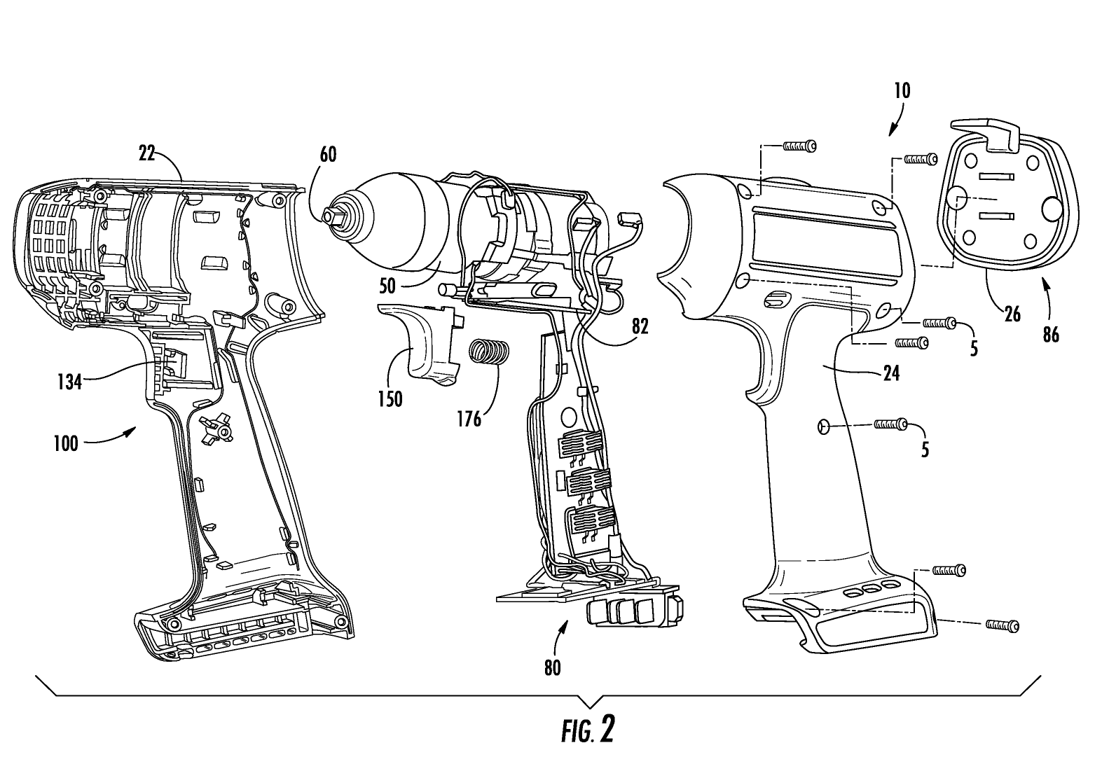

Turning to the power tool 10 in more detail and with reference to FIGS. 1 and 2, the power tool 10 includes a protective housing assembly 20, a drive motor assembly 50, a tool output shaft or drive head 60, a battery pack 70 (not shown in FIG. 2), and a control system 80.

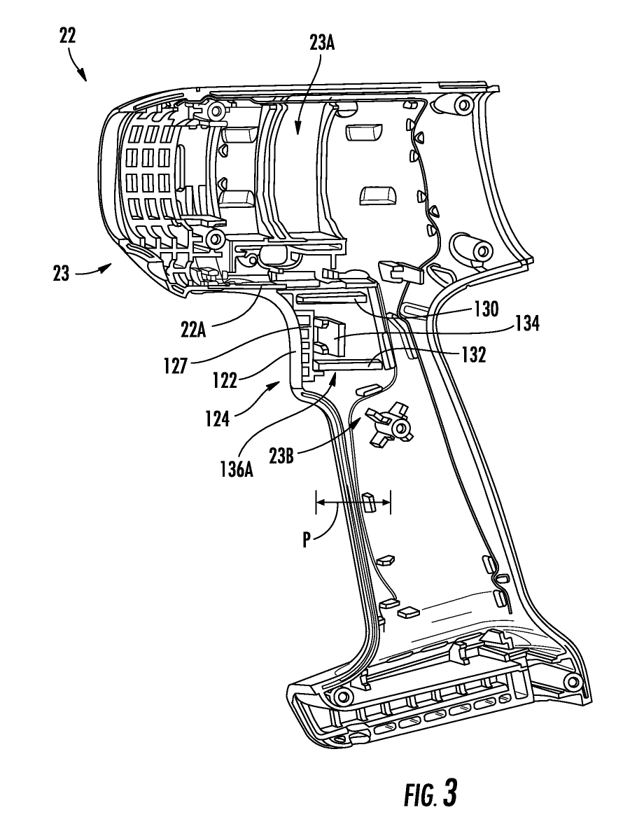

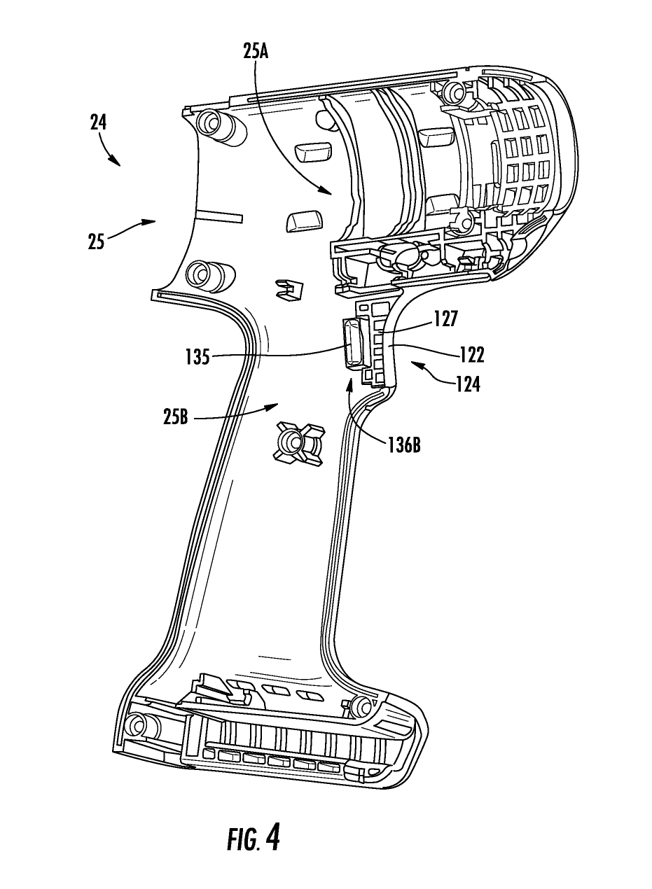

The housing assembly 20 includes a housing 30 having an upper or main body portion 34 and a pistol grip or handle 32 depending therefrom. The housing 30 is formed by a right shell or housing member 22 (FIG. 3) and a left shell or housing member 24 (FIG. 4). The housing assembly 20 further includes a rear cover or protective display housing 26 (FIG. 1). Referring to FIGS. 3 and 4, the right housing member 22 defines a cavity 23 having an upper cavity portion 23A and a lower cavity portion 23B separated by a partition wall 22A. The left housing member 24 defines a cavity 25 having an upper cavity portion 25A and a lower cavity portion 25B. When assembled, the housing 30 defines an enclosed lower chamber (comprising the lower cavity portion 23A and the lower cavity portion 25A) and an enclosed upper chamber (comprising the upper cavity portion 23B and the upper cavity portion 25B). Latch or coupling features on the housing members 22, 24 and/or fasteners (such as screws 5 (FIG. 2) can be provided to affix the housing members 22, 24 to one another.

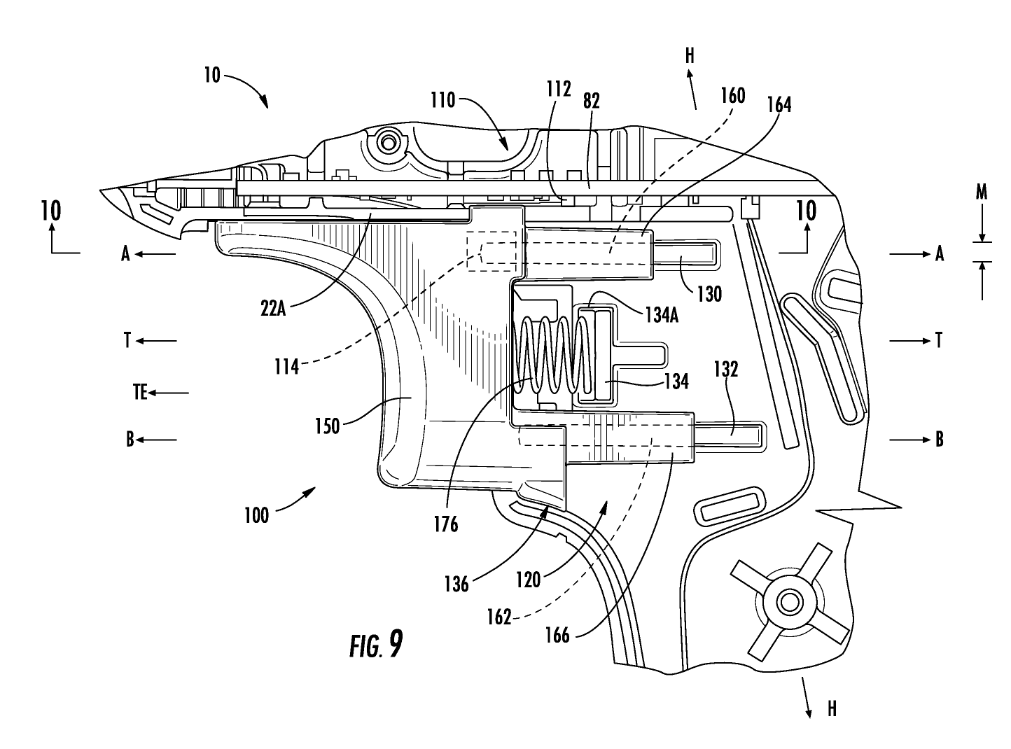

Referring to FIG. 1, according to some embodiments and as illustrated, the power tool 10 has a pistol grip form factor, the handle 32 being configured to be grasped and held in use (i.e., when applying a force using the drive motor assembly 50) in the manner of a pistol grip. A trigger member 150 forming a part of the trigger system 100 is located on a front side of the handle 32 such that the operator's finger (e.g., index finger) is typically positioned proximate the trigger member 150 when the operator is holding the handle 32. The handle 32 defines a heightwise axis H-H (FIGS. 1 and 9). In the case of a pistol grip handle 32, the operator will ordinarily wrap his or her fingers around the heightwise axis H-H. The drive head 60 may define a tool drive axis D-D (FIG. 1; e.g., the axis of rotation of a rotary drive head 60) that is transverse to (and intersects) the heightwise axis H-H. According to some embodiments, the axes D-D and H-H form an included angle in the range of from about 70 degrees to about 90 degrees.

According to some embodiments, the right housing member 22 and the left housing member 24 are each monolithic and/or unitarily formed. According to some embodiments, the right housing member 22 and the left housing member 24 are each unitarily molded components. In some embodiments, the right housing member 22 and the left housing member 24 are each unitarily injection molded.

The right housing member 22 and the left housing member 24 may be formed of any suitable material(s) or compositions(s). According to some embodiments, the entirety of each housing member 22, 24 is formed of the same material or composition. According to some embodiments, the housing members 22, 24 are formed of a polymeric material. According to some embodiments, the housing members 22, 24 are formed of glass-filled nylon. The material of the housing members 22, 24 is rigid or semi-rigid at room temperature and, according to some embodiments, has a Young's Modulus of at least about 2.0 GPa and, according to some embodiments, in the range of from about 2.0 GPa to 2.8 GPa.

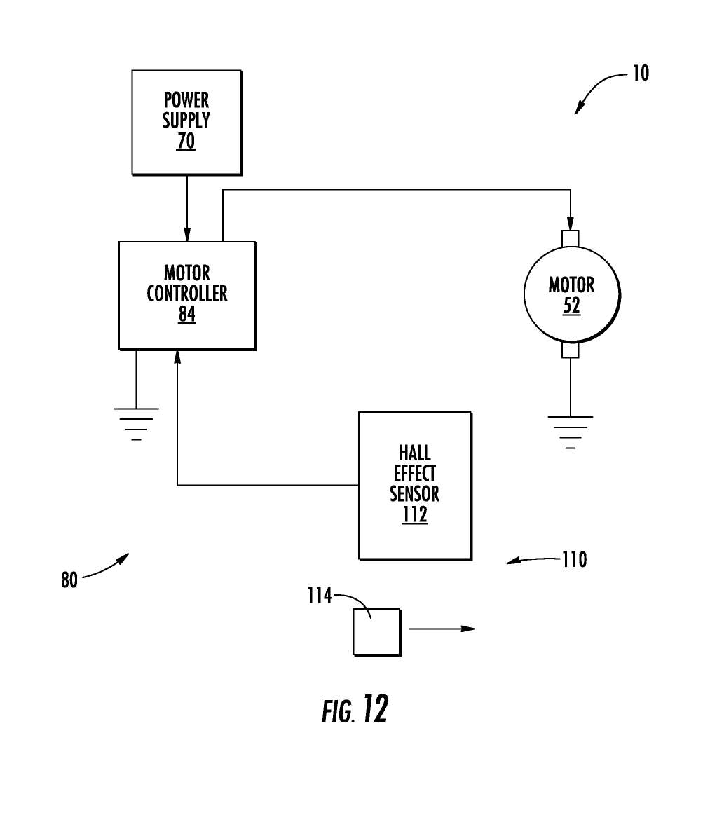

The drive motor assembly 50 and the battery pack 70 are contained in or attached to the housing 30. In the illustrated embodiment, the motor assembly 50 is contained in the upper chamber or main body 34, and the battery pack 70 is releasably mounted on the lower end of the handle 32. The construction and operation of drive motor assemblies and battery packs in handheld power tools are well known to those of skill in the art and will not be discussed in detail herein. The drive motor assembly 50 may include an electric motor 52 (FIG. 12) arranged and configured (directly or via a gearcase, linkage or gear system) to selectively drive (e.g., rotate) the drive head 60 using power supplied from the battery pack 70. According to some embodiments, the motor 52 is a DC electric motor.

The control system 80 (FIG. 2) may be in whole or in part contained in and/or attached to the housing 30. Control systems for handheld power tools are well known to those of skill in the art and therefore will not be described herein in detail. The exemplary control system 80 as illustrated includes a control printed circuit board (PCB) assembly 82 (FIG. 9) and a trigger system 100. The control system 80 includes a motor controller 84. According to some embodiments, the motor controller 84 (FIG. 12) is a microcontroller (e.g., mounted on the PCB assembly 82). In some embodiments, the microcontroller 84 includes pulse width modulation (PWM) circuitry configured to generate a variable PWM voltage duty cycle (i.e., percentage of time voltage is applied to motor 52). The control system 80 may further include a human-machine interface (HMI) assembly 86 (FIG. 1) including, for example, a keypad, a display device (e.g., a liquid crystal display (LCD) or an organic light emitting diode (OLED) display), and indicator lights.

The HMI assembly 86 and the trigger system 100 collectively form a human machine interface (HMI) 90 operative to display information to an operator and receive information and/or commands from the operator. In particular, the trigger system 100 enables the operator to actuate and deactuate the drive motor assembly 50 to drive the drive head 60.

With reference to FIG. 9, the trigger system 100 includes a switch system 110, a housing receptacle 120, the trigger member 150, and a biasing member or spring 176.

With reference to FIGS. 9 and 12, the switch system 110 includes a trigger switch sensor 112 mounted on the control PCB 82 and a trigger magnet 114 (e.g., a permanent magnet) mounted on the trigger member 150 as described hereinbelow. According to some embodiments, the trigger switch sensor 112 is a Hall Effect sensor. According to some embodiments, the trigger switch sensor 112 is a latching Hall Effect sensor and, in some embodiments, a digital latching Hall Effect sensor. Suitable latching Hall Effect sensors may include the MLX92213 Hall Effect sensor available from Melexis Microelectronic Integrated Systems of leper, Belgium. The trigger switch sensor 112 is electrically connected to the motor controller 84 and is configured to provide a reference or output signal (e.g., a sensor output voltage; e.g., 0 to 5 volts) to the motor controller 84 corresponding to the position of the magnet 114 relative to the sensor 112. The motor controller 84 is configured to control the power or voltage applied to the motor 52 dependent on or as a function of the received sensor output voltage from the sensor 112.

Referring to FIGS. 1-5, the housing receptacle 120 includes a pair of front flanges 122 integrally formed with the right and left housing members 22, 24, respectively. The front flanges 122 are curved and define respective front open perimeters or slots 124 that, when the housing members 22, 24 are mated, define an open space or trigger opening 126 that holds the trigger member 150, and a lower lip 128. The housing receptacle 120 (FIG. 9) also includes bracing features 127 integrally formed on each of the housing members 22, 24 (FIGS. 3 and 4).

The housing receptacle 120 further includes an upper guide feature in the form of an upper linear guide rail or rib 130 and a lower guide feature in the form of a lower linear guide rail or rib 132 on the right housing member 22. The upper guide rib 130 defines an upper guide axis A-A and the lower guide rib 132 defines a lower guide axis B-B (FIG. 9). According to some embodiments, the guide ribs 130, 132 are integral with and unitarily formed with the right housing member 24 (e.g., monolithic). According to some embodiments, the guide ribs 130, 132 are unitarily injection molded to form monolithic, integral components of the right housing member 22.

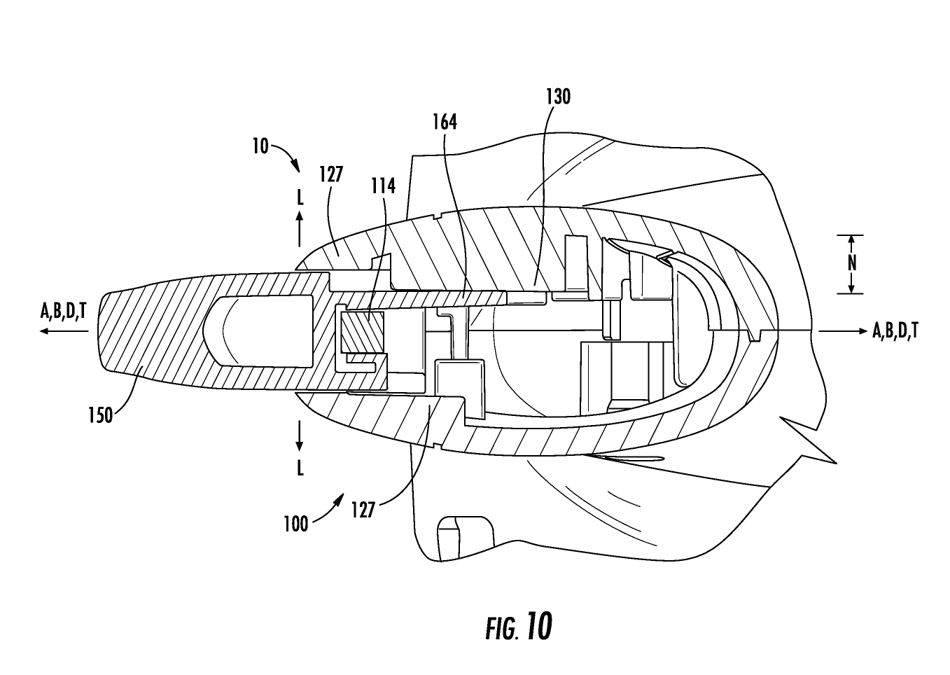

According to some embodiments, each guide rib 130, 132 has a height M (FIG. 9) in the range of from about 1 mm to 2 mm. According to some embodiments, the guide ribs 130, 132 have a width N (FIG. 10) in the range of from about 3 mm to 4 mm. According to some embodiments, the guide ribs 130, 132 have a length P (FIG. 3) in the range of from about 20 mm to 21 mm.

As shown in FIG. 3, the housing receptacle 120 further includes a spring support feature 134. According to some embodiments, the spring support feature 134 is integral and unitarily formed with the right housing member 22 and, according to some embodiments, is unitarily injection molded with the right housing member 22. The spring support feature 134 may include a spring mount slot 134A (FIG. 9) configured to capture an end of the spring 176.

The right housing member 22 defines a right seat 136A (FIG. 3) configured to receive a right side portion of the trigger member 150. The left housing member 24 defines a left seat 136B (FIG. 4) configured to receive a left side portion of the trigger member 150. When the housing members 22, 24 are fully assembled and mated as shown in FIG. 9, the right seat 136A and the left seat 136B collectively form a combined trigger seat 136.

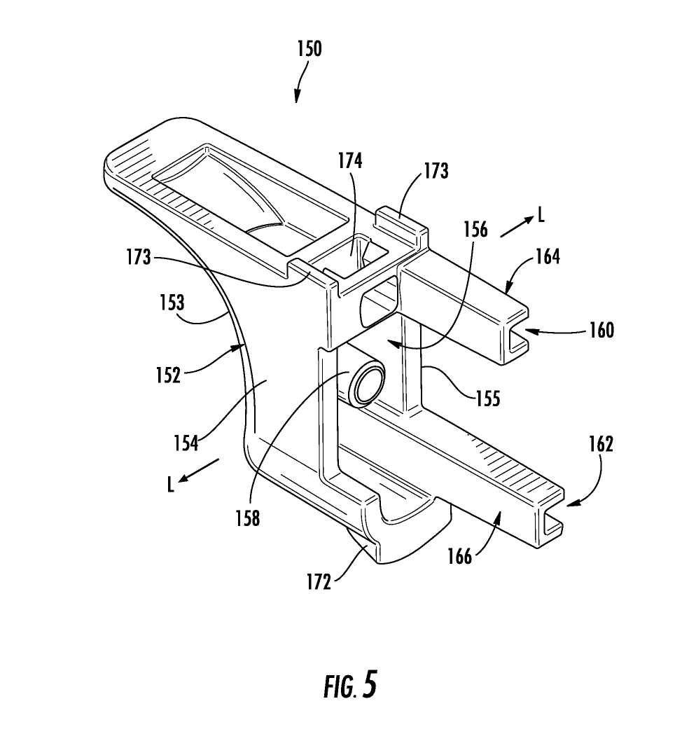

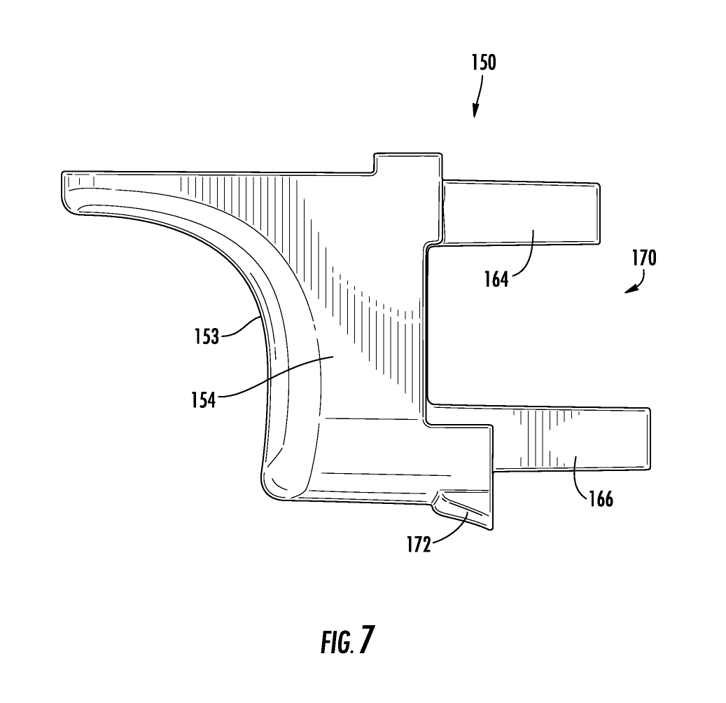

Referring to FIGS. 5 and 7, the trigger member 150 includes a body 152 having an engagement face 153, a left lateral side face 154 and an opposing right lateral side face 155. The opposed lateral side faces 154 and 155 are spaced apart along a lateral axis L-L (FIGS. 5, 8 and 10) that extends transversely (and, in some embodiments, perpendicularly) to the heightwise axis H-H. The body 152 defines an interior cavity 156 and further includes an integral spring post 158 disposed in the cavity 156. A stop feature 172 is located on a front, lower portion of the body 152 and a pair of opposed stop features 173 are located on a top portion of the body 152. A magnet cavity 174 is defined in an upper portion of the body 152 to hold the magnet 114 (FIGS. 9 and 10) therein.

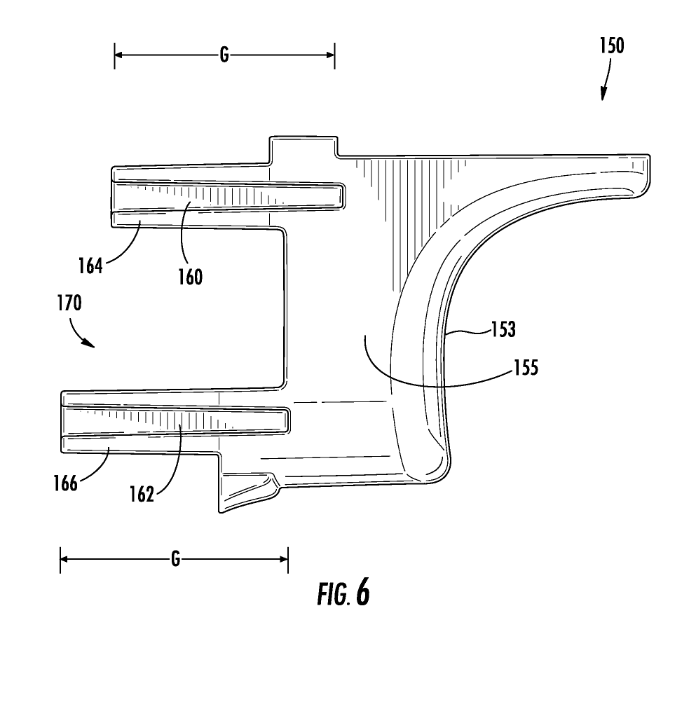

Referring to FIGS. 5-7, the trigger member 150 further includes an upper, axially extending extension 164 and a lower, axially extending extension 166. An upper trigger guide feature is provided in the form of an upper guide groove or slot 160 defined in the right lateral side face 155 and the upper extension 164. A lower trigger guide feature is provided in the form of a lower guide groove or slot 162 defined in the right lateral side face 155 and the lower extension 166. Each guide slot 160, 162 is defined by a bottom wall 167 and opposed side walls 168. A slot, open space or gap 170 (FIG. 6) is defined between the extensions 164, 166.

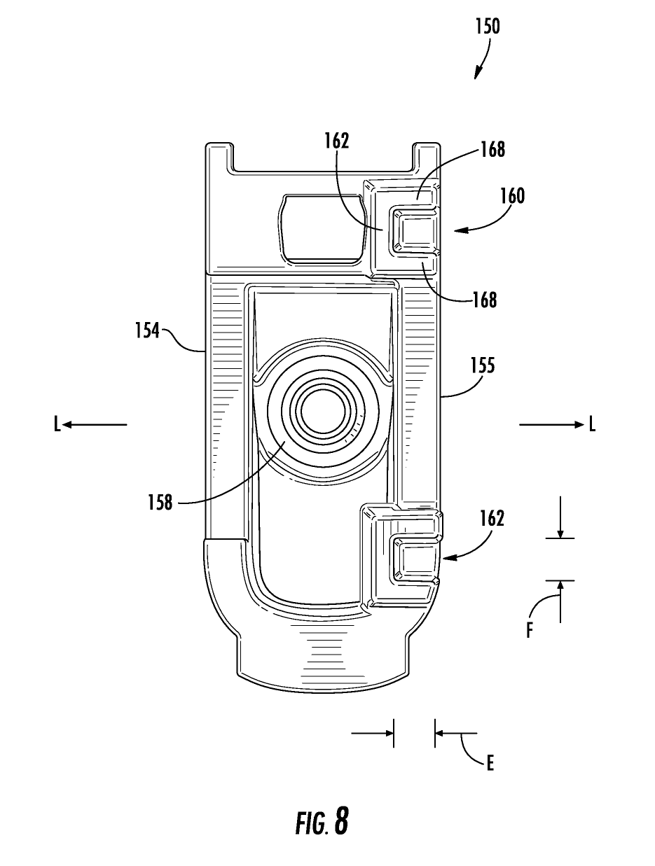

According to some embodiments, each guide slot 160, 162 has a depth E (FIG. 8) in the range of from about 2 mm to 3 mm. According to some embodiments, each guide slot 160, 162 has a height F (FIG. 8) in the range of from about 1.5 mm to 2.5mm. According to some embodiments, each guide slot 160, 162 has a length G (FIG. 6) in the range of from about 20 mm to 21 mm. According to some embodiments, each of the bottom and side walls of each extension 164, 166 has a thickness in the range of from about 1.5 mm to 2.5 mm.

Notably, referring to FIG. 5, according to some embodiments and as illustrated, the guide slots 160, 162 are located on the right lateral side 155 of the trigger member 150 and there are no guide features (e.g., guide ribs or slots) on the left lateral side 154 of the trigger member 150. According to some embodiments and as illustrated in FIGS. 5 and 7, the left lateral side 154 is substantially smooth with a straight line perimeter and terminates behind lower stop 172.

Referring to FIG. 5, the body 152, spring post 158, guide grooves 160, 162, extensions 164, 166 and stop features 172, 173 are integral with one another to form a unitary trigger member 150 and, according to some embodiments, a monolithic trigger member 150. According to some embodiments, the trigger member 150 is unitarily formed. According to some embodiments, the trigger member 150 is unitarily molded. In some embodiments, the trigger member 150 is unitarily injection molded as a monolithic body.

The trigger member 150 may be formed of any suitable material(s) or compositions(s). According to some embodiments, the entirety of the trigger member 150 is formed of the same material or composition. According to some embodiments, the trigger member 150 is formed of a polymeric material. According to some embodiments, the trigger member 150 is formed of glass-filled nylon. The material of the trigger member 150 can be rigid or semi-rigid at room temperature. According to some embodiments, the material of the trigger member 150 has a Young's Modulus of at least about 2.0 GPa and, according to some embodiments, in the range of from about 2.0 GPa to about 2.8 CPa.

The construction of the power tool 10 and the trigger system 100 will be further appreciated from the following description of methods according to embodiments of the invention for assembling the power tool 10. It will be understood that various of the steps described herein may be modified and/or executed in a different order.

The drive motor assembly 50 is mounted in the upper cavity 23A of the right housing member 22. The control PCB 82 is also mounted in the upper cavity 23A proximate the partition wall 22A such that the trigger switch sensor 112 is located above the lower cavity 23B.

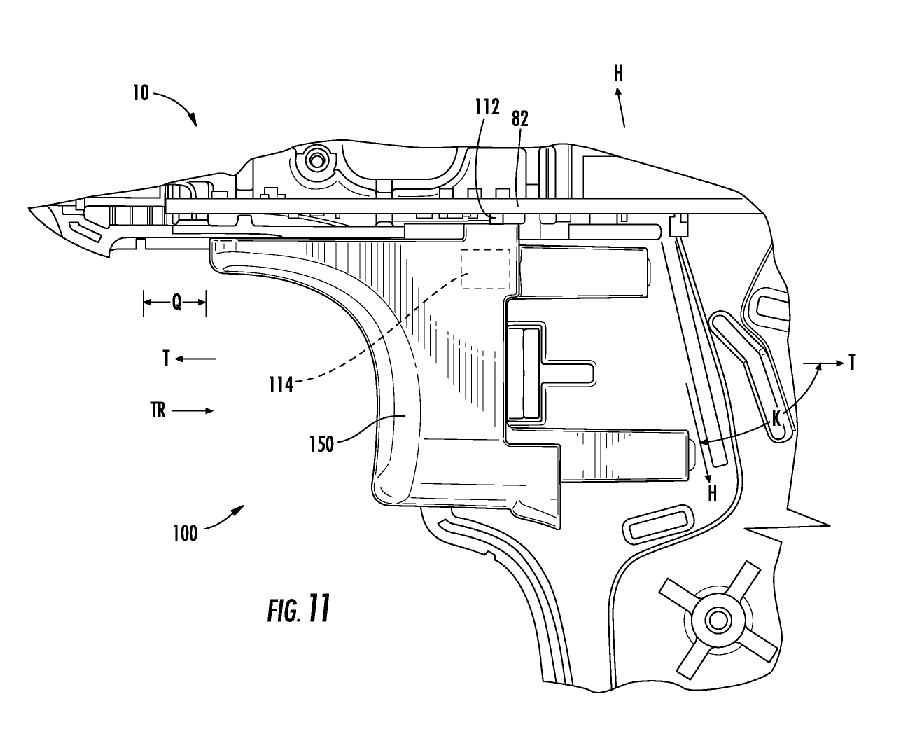

Referring to FIGS. 10 and 11, the magnet 114 is installed in the magnet cavity 174 of the trigger member 150. According to some embodiments, the magnet 114 is oriented in the cavity 174 such that the magnet's polarity axis is substantially parallel with the slide axis of the trigger member 150. For example, the magnet 114 may be installed such that its North pole is proximate the rear end of the trigger member 150 and its South pole is proximate the front end of the trigger member 150.

The spring 176 is mounted on the spring post 158 in the cavity 156 of the trigger member 150.

As shown in FIGS. 9 and 10, the trigger member 150, with the magnet 114 and the spring 176 premounted thereon, is laid into the seat 136A (FIG. 3) defined by the right housing member 22. More particularly, the trigger member 150 is laid into the seat 136A such that the upper guide rib 130 nests or seats in the upper guide slot 160 and the lower guide rib 132 nests or seats in the lower guide slot 162. The magnet 114 is thereby positioned proximate the partition wall 22A. The spring 176 is captured and partially compressed between the trigger member 150 and the spring support feature 134. The rear end of the spring 176 is slid laterally into and captured within the spring capture slot 134A.

The left housing member 24 is mounted on the right housing member 22 to form the handle 32 and the main body 34 of the housing 30. The trigger member 150 is thereby captured between the bracing features 127 (FIGS. 3 and 4). According to some embodiments, each of the foregoing assembly steps is executed prior to installing the left housing member 24 on the right housing member 22. The left housing member 24 is installed such that the left lateral side portion of the trigger member 150 is received in the left seat 136B and the overall seat 136 and the trigger opening 126 are formed. A portion of the trigger member 150 projects forwardly through the opening 126. The housing members 22, 24 can be secured together by the latch features and/or fasteners 5. The spring support feature 134 can be received in a slot of a counterpart spring support feature 135 (FIG. 4) integral with the left housing member 24.

In use, the trigger system 100 can be used in any suitable manner by the operator to selectively actuate and deactuate the motor 52 of the drive motor assembly 50 to drive the drive head 60.

More particularly, the trigger member 150 is slidable in the seat 136 between a released or extended position as shown in FIGS. 1, 9 and 10 and a depressed or retracted position as shown in FIG. 11. The open space 170 (FIG. 7) provides clearance for the spring support feature 134. In transitioning between the extended and retracted positions, the guide slots 160, 162 slide along the guide ribs 130, 132 and thereby constrain movement of the trigger member 150 to a trigger slide axis T-T that is substantially parallel to the upper guide axis A-A and the lower guide axis B-B. As shown in FIG. 10, the trigger slide axis T-T extends transversely (and, in some embodiments, substantially perpendicularly) to the lateral axis L-L. According to some embodiments, the axes L-L and H-H form an included angle K (FIG. 11) in the range of from about 70 degrees to about 90 degrees.

The trigger member 150 is biased toward the extended position by the spring 176. Extension of the trigger member 150 is limited by the stop features 172, 173 and the lip 128.

The trigger system 100 serves to actuate the motor 52 when the trigger member 150 is retracted and to deactuate the motor 52 when the trigger member 150 is extended. When the trigger member 150 is in its extended position, (e.g., as shown in FIG. 9), the magnet 114 is positioned relative to the Hall Effect sensor 112 such that the sensor 112 is not actuated. When the trigger member 150 is displaced or pulled by the operator in a retraction direction TR (FIG. 11), the magnet 114 is thereby repositioned with respect to the Hall Effect sensor 112 and actuates the sensor 112. When the trigger member 150 is released, it returns in an extension direction TE (FIG. 9) to the extended position, thereby again positioning the magnet 114 relative to the Hall Effect sensor 112 such that the sensor 112 is not actuated. In this way, the trigger system 100 incorporating a Hall Effect sensor can provide a noncontact trigger switch system. However, according to some embodiments, other types and configurations of trigger actuators may be employed.

Where the Hall Effect sensor 112 is a latching Hall Effect sensor, the sensor 112 will be actuated (i.e., latched “on”) when the strength of the magnetic field applied to the sensor 112 exceeds an actuation threshold and the sensor 112 will respond thereto by generating a corresponding sensor output signal (e.g., an output voltage) to the motor controller 84. The motor controller 84 will respond to the sensor output signal by turning the motor 52 on (e.g., applying a voltage to the motor 52 sufficient to run the motor 52). The latching Hall Effect sensor 112 will be deactuated (i.e., latched “off”) when the strength of the magnetic field applied to the sensor 112 by the magnet 114 is below the actuation threshold. In this case, the sensor 112 will not generate the sensor output signal to the motor controller 84, and the motor controller 84 will turn the motor 52 off (e.g., by not applying a sufficient voltage to the motor 52 to run the motor 52).

As used herein, the strength of the magnetic field refers to the magnetic flux density applied to or experienced by the sensor 112. Other switch system configurations may be employed. For example, the Hall Effect sensor 112 may be configured to switch its latched state (on or off) depending on the polarity of the applied magnetic field and the trigger system 100 may be configured to position one polar end of the magnet 114 proximate the sensor 112 when the trigger member 150 is extended and to position the opposite polar end of the magnet 114 proximate the sensor 112 when the trigger member 150 is retracted.

According to some embodiments, in the case of a latching Hall Effect sensor 112, the motor controller 84 will apply substantially zero voltage to the motor 52 when the trigger member 150 is in the “off” position, and will operate the motor 52 at only one non-zero or “on” speed when the trigger member 150 is in the “on” position, namely, a designed maximum speed with full designed voltage applied to the motor 52. That is, the latching Hall Effect sensor 112 and the motor controller 84 provide binary on/off control of the motor 52. In some embodiments, the motor controller 84 may include ramping circuits and/or functions that may provide for gradual transition between actuated and unactuated states of the motor 52. As discussed below, tools according to further embodiments of the invention can employ a linear Hall Effect sensor enabling multiple, varied positive motor speed control.

According to some embodiments, the slide distance Q (FIG. 11) of the trigger member 150 from the extended position to the retracted position is in the range of from about 6.5 mm to 7.5 mm.

According to some embodiments, the length P (FIG. 3) of each guide rib 130, 132 is at least as great as the length G (FIG. 6) of the associated guide groove 160, 162. According to some embodiments, the tolerance between the height M (FIG. 9) of each guide rib 130, 132 and the height F (FIG. 8) of its associated guide groove 160, 162 is in the range of from about 2.0 mm to about 2.5 mm. According to some embodiments, the width N (FIG. 10) of each guide rib 130, 132 is greater than the depth E (FIG. 8) of its associated guide groove 160, 162.

The power tool 10 and trigger system 100 as disclosed herein can provide a number of advantages. The upper linear guide features 130, 160 and the lower linear guide features 132, 162 spaced apart along the heightwise axis H-H (e.g., vertically stacked) limit the trigger member 150 to a linear slide path relative to the housing assembly 20 and inhibit or prevent cocking or rotation of the trigger member 150 about the lateral axis L-L. Thus, the trigger system 100 can resist the tendency to cock and bind when an operator pulls on the trigger member 150 off-center, for example.

The trigger system 100 can simplify, expedite and/or ease assembly of the power tool 10. Because, according to some embodiments, the trigger mounting and guide features are all embodied on the right lateral side face 154 of the trigger member 150 and the right housing member 22, it is only necessary to align the trigger member guide features 160, 162 with the open right housing member 22. The left housing member 24 can then be easily mounted on the right housing member 22 and the trigger member 150 without special effort to align the left housing member 24 with the trigger member 150. Because the trigger member 150 is directly mounted on and captured between the housing members 22, 24, the number of pieces required to assemble the trigger system 100 is significantly reduced.

In some embodiments, a power tool as described is provided with a switch system using a Hall Effect sensor configured to provide a variable output signal that is a function of the magnetic field applied to the Hall Effect sensor by the magnet mounted on the trigger member 150, the applied magnetic field strength being a function of the position of the trigger member 150 with respect to the Hall Effect sensor as discussed.

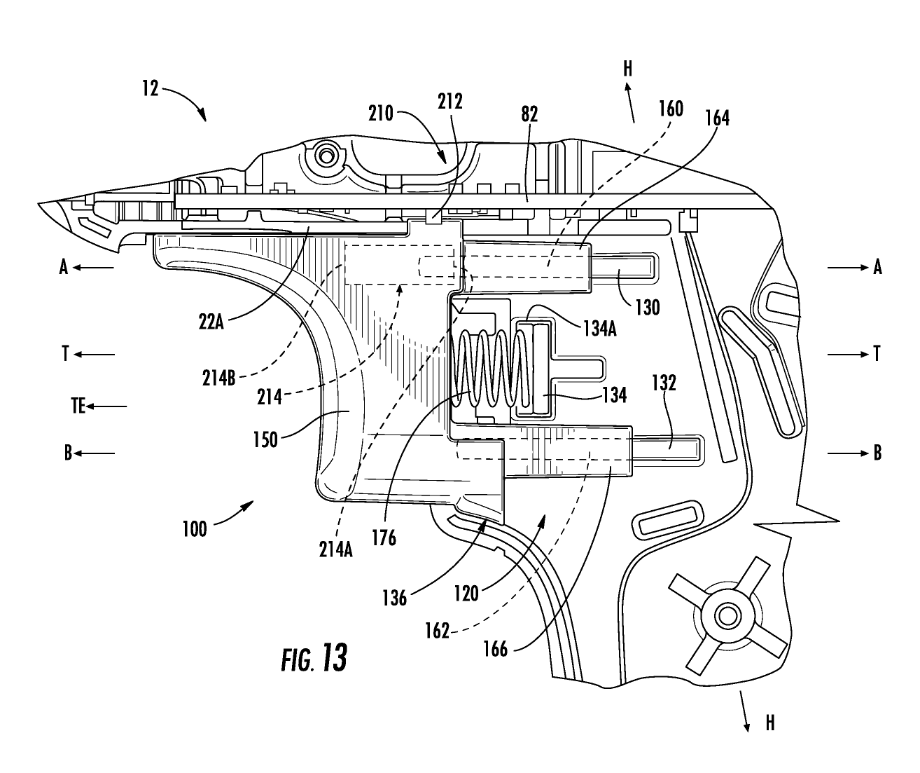

With reference to FIGS. 13-15, a power tool 12 of this type according to further embodiments of the invention is shown therein. The power tool 12 is constructed and configured in the same manner as the power tool 10 except as discussed below, and like numbers in the drawings refer to like elements.

The tool 12 includes a control system 280 including a switch system 210. The switch system 210 includes a linear Hall Effect sensor 212 in place of the latching Hall Effect sensor 112 and an elongate trigger magnet 214 (e.g., a permanent magnet) in place of the magnet 114. The trigger magnet 114 is mounted in the trigger member 150 such that one pole 214A (e.g., the North pole) thereof is located proximate the rear end of the trigger member 150 and the opposed pole 214B (e.g., the South pole) thereof is located proximate the front end of the trigger member 150.

The linear Hall Effect sensor 212 is electrically connected to a motor controller 284 (corresponding to the motor controller 84). The sensor 212 may be mounted on the PCB assembly 82. The motor controller 284 may be a microcontroller including PWM circuitry configured to generate a variable PWM voltage duty cycle. The sensor 212 is configured to provide a reference signal or sensor output signal to the motor controller 284. The motor controller 284 is configured to control the power or voltage applied to the motor 52 dependent on or as a function of the received sensor output voltage from the linear Hall Effect sensor 212.

In use, the linear Hall Effect sensor 212 senses the position of the magnet 214 (and thereby the position of the trigger member 150) to provide a substantially proportional electrical output signal, which is used by the motor controller 284 to regulate the speed of the motor 52. More particularly, the strength of the magnetic field applied to the sensor 212 by the magnet 214 will vary with the position of the trigger member 150 and the magnet 214. The sensor output voltage (e.g., 0 to 5 volts) generated by the sensor 212 is substantially proportional to the strength of the magnetic field applied thereto. The motor controller 284 converts the sensor output voltage to a corresponding motor control voltage or duty cycle that is applied to the motor 52.

In this manner, the control system 280 provides a non-contact, variable speed switch for selectively actuating the motor 52 to run at different non-zero speeds using the trigger member 150. Contactless switching as described can provide improved reliability and durability as compared to other known variable speed switches, such as switch mechanisms using a mechanical wiper on a resistive contact surface. The control system 280 can thus significantly increase the effective life of the tool. This can be especially beneficial for improving the utility of the power hand tool for high volume, repeated cycle rate applications in production assembly.

In some embodiments, the linear Hall Effect sensor 212 is a ratiometric linear Hall Effect sensor. Suitable linear Hall Effect sensors may include the Allegro A1324 linear Hall Effect sensor available from Allegro Microsystems, Inc. of Worcester, Mass.

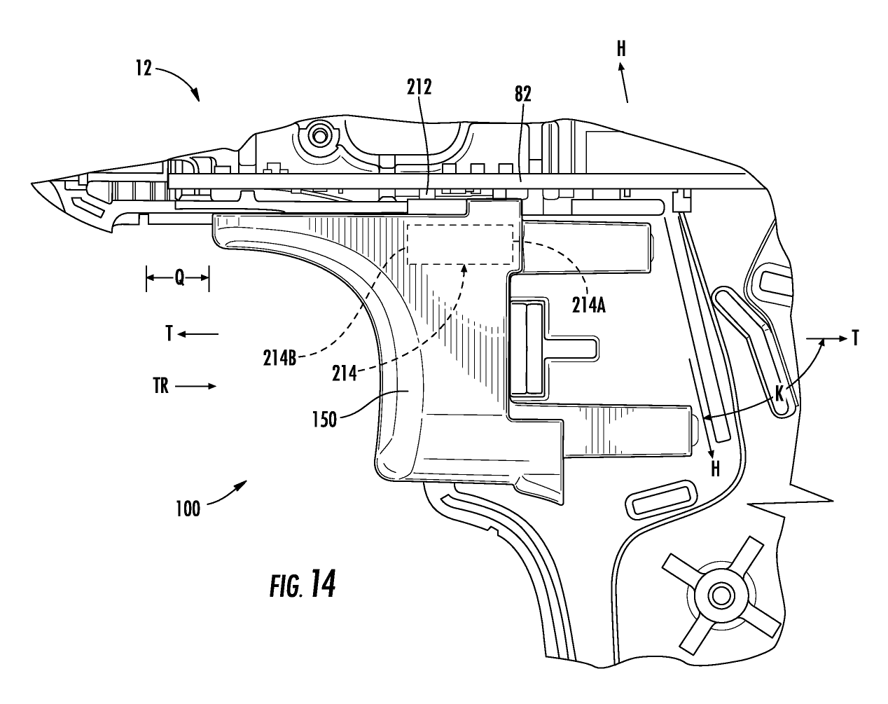

According to some embodiments, the control system 280 is configured such that the magnetic flux density applied to the sensor 212 varies from a minimum to a maximum value, or from a maximum to a minimum value, as the trigger member 150 is displaced from its fully extended position to its fully depressed position. According to some embodiments, the switch system 210 is configured in a slide-by sensing configuration or arrangement. In the slide-by configuration, the magnet 214 physically slides past the sensor 212 in a direction from pole 214A to pole 214B (during trigger depression) and in a direction from pole 214B to 214A (during trigger release or extension). In some embodiments, the sensor 212 is positioned proximate the pole 214A and distal from the pole 214B when the trigger member 150 is in its extended position (FIG. 13) and is positioned proximate the pole 214B and distal from the pole 214A when the trigger member 150 is in its fully retracted or depressed position (FIG. 14). This configuration can provide a more linear relative displacement to output voltage response. However, other sensor/magnet configurations may be used, such as a head-on sensing configuration (wherein one pole of the magnet is moved with respect to the sensor without sliding the magnet past the sensor), a push-pull configuration (wherein two opposed, complementary magnets are mounted on the trigger member 150 and slide past the sensor 212), or a push-push configuration (wherein two opposed magnets with opposing fields are mounted on the trigger member 150 and slide past the sensor 212).

In some embodiments, the variable output signal or voltage provided by the Hall Effect sensor 212 is substantially linearly proportional to the magnetic field applied thereto. Power tools according to some embodiments of the invention may include switch systems using a Hall Effect sensor providing a variable output signal as described that is not substantially linearly proportional to the applied magnetic field strength, but may instead by otherwise proportional (e.g., logarithmically proportional) to the applied magnetic field strength. In some embodiments, the Hall Effect sensor incorporates hysteresis (e.g., using a Schmitt trigger).

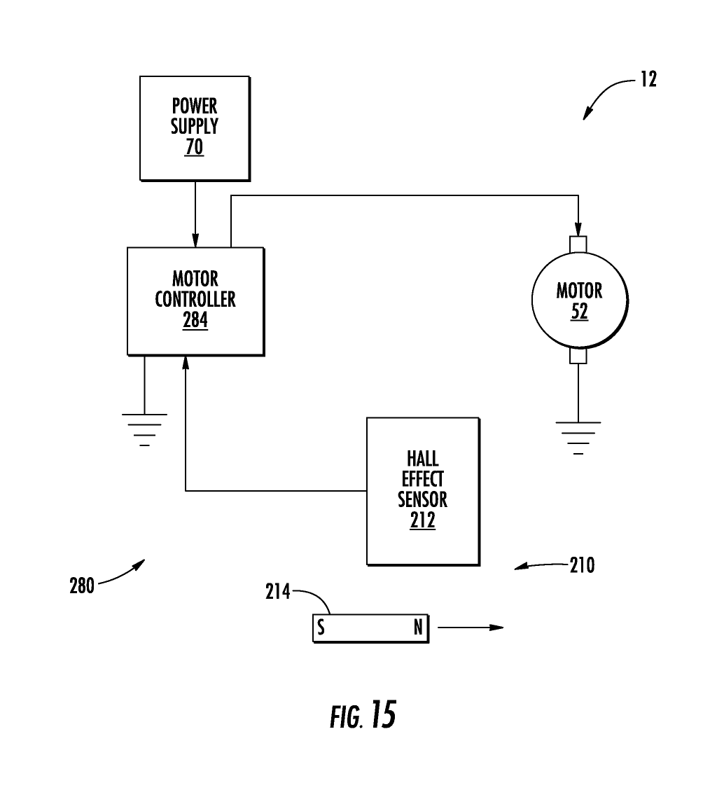

While the simplified schematic electrical diagrams of FIGS. 12 and 15 have been provided herein for the purpose of explanation, it will be appreciated that further and alternative components and configurations may be provided in accordance with embodiments of the invention. For example, one or more buffering components (e.g., power transistors) may be provided in the motor control circuit to isolate the microcontroller 84, 284 from the power supply 70.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

1. A handheld power tool comprising:
a housing assembly having a grip portion having a heightwise axis, the housing assembly including a housing member having parallel upper and lower housing guide features spaced apart along the heightwise axis; and
a trigger member mounted in the housing assembly to slide along a slide axis transverse to the heightwise axis, the trigger member including parallel upper and lower trigger guide features spaced apart along the heightwise axis and mated with the upper and lower housing guide features;
wherein the upper and lower housing guide features and the upper and lower trigger guide features cooperate to limit the trigger member to a linear slide path relative to the housing assembly and inhibit cocking of the trigger member about a lateral axis transverse to each of the heightwise axis and the slide axis.

2. The handheld power tool of claim 1 wherein:
the housing member is a first housing member;
the housing assembly further includes a second housing member and the first and second housing members collectively define the grip portion; and
the trigger member is captured between and directly mounted on each of the first and second housing members.

3. The handheld power tool of claim 1 wherein:
the upper and lower housing guide features include upper and lower linear guide ribs, respectively;
the upper and lower trigger guide features include upper and lower linear guide slots, respectively; and
the upper and lower linear guide ribs are slidably nested in the upper and lower linear guide slots, respectively.

4. The handheld power tool of claim 1 wherein:
the trigger member has first and second opposed lateral sides spaced apart along the lateral axis; and
the upper and lower trigger guide features are located on the first lateral side of the trigger member and the second lateral side of the trigger member is devoid of guide features.

5. The handheld power tool of claim 1 wherein the trigger member is a monolithic body.

6. The handheld power tool of claim 1 including a noncontact switch system including:
a Hall Effect sensor mounted on or in the housing assembly; and
a magnet mounted on the trigger member for movement therewith relative to the Hall Effect sensor.

7. The handheld power tool of claim 6 wherein the Hall Effect sensor is a latching Hall Effect sensor.

8. The handheld power tool of claim 6 wherein the Hall Effect sensor is configured to provide a variable output signal that is a function of a magnetic field applied to the Hall Effect sensor by the magnet, wherein the applied magnetic field strength is a function of the position of the trigger member with respect to the Hall Effect sensor.

9. The handheld power tool of claim 8 wherein the Hall Effect sensor is a linear Hall Effect sensor and the variable output signal is substantially proportional to the strength of the magnetic field applied to the linear Hall Effect sensor by the magnet, wherein the applied magnetic field strength is substantially proportional to the position of the trigger member with respect to the linear Hall Effect sensor.

10. The handheld power tool of claim 1 including a biasing member biasing the trigger member into an extended position.

11. The handheld power tool of claim 1 including a battery pack and wherein the handheld power tool is a cordless handheld power tool.

12. A method for assembling a handheld power tool, the method comprising:
providing a housing assembly having a grip portion having a heightwise axis, the housing assembly including a housing member having parallel upper and lower housing guide features spaced apart along the heightwise axis; and
mounting a trigger member in the housing assembly to slide along a slide axis transverse to the heightwise axis, and such that parallel upper and lower trigger guide features of the trigger member are spaced apart along the heightwise axis and mated with the upper and lower housing guide features;
wherein, in the assembled handheld power tool, the upper and lower housing guide features and the upper and lower trigger guide features cooperate to limit the trigger member to a linear slide path relative to the housing assembly and inhibit cocking of the trigger member about a lateral axis transverse to each of the heightwise axis and the slide axis.

13. The method of claim 12 wherein:
the housing member is a first housing member;
the housing assembly further includes a second housing member; and
mounting the trigger member in the housing assembly includes capturing the trigger member between the first and second housing members such that the trigger member is directly mounted on each of the first and second housing members and the first and second housing members collectively define the grip portion.

14. The method of claim 12 wherein:
the upper and lower housing guide features include upper and lower linear guide ribs, respectively;
the upper and lower trigger guide features include upper and lower linear guide slots, respectively; and
mounting the trigger member in the housing assembly includes slidably nesting the upper and lower linear guide ribs in the upper and lower linear guide slots, respectively.

15. The method of claim 12 wherein:
the trigger member has first and second opposed lateral sides spaced apart along the lateral axis; and
the upper and lower trigger guide features are located on the first lateral side of the trigger member and there are no guide features on the second lateral side of the trigger member.

16. The method of claim 12 including unitarily injection molding the trigger member.

17. The method of claim 12 including assembling a noncontact switch system in the housing assembly, including:
mounting a Hall Effect sensor on or in the housing assembly; and
mounting a magnet on the trigger member for movement therewith relative to the Hall Effect sensor.

18-23. (canceled)

24. A handheld power tool comprising:
a housing;
an electric motor mounted in the housing; and
a trigger system including:
a trigger member movably mounted in the housing; and
a noncontact switch system to selectively control actuation of the electric motor, the noncontact switch system including:
a Hall Effect sensor mounted on or in the housing; and
a magnet mounted on the trigger member for movement therewith relative to the Hall Effect sensor.

25. The handheld power tool of claim 24 wherein the Hall Effect sensor is a latching Hall Effect sensor.

26. The handheld power tool of claim 24 wherein the Hall Effect sensor is configured to provide a variable output signal that is a function of a magnetic field applied to the Hall Effect sensor by the magnet, wherein the applied magnetic field strength is a function of the position of the trigger member with respect to the Hall Effect sensor.

27. The handheld power tool of claim 26 wherein the Hall Effect sensor is a linear Hall Effect sensor and the variable output signal is substantially proportional to the strength of the magnetic field applied to the linear Hall Effect sensor by the magnet, wherein the applied magnetic field strength is substantially proportional to the position of the trigger member with respect to the linear Hall Effect sensor.
